(19) United States
(12) Patent Application Publication
(10) Pub. No.: US 2010/0095568 A1
(43) Pub. Date: Apr. 22, 2010

(54) PHOTO DISPLAY PEN

(76) Inventor: Jamieson A. Foght, Waunakee, WI (US)

Correspondence Address: Intellectual Property Dept.;Dewitt Ross & Stevens SC, 2 East Mifflin Street, Suite 600, Madison, WI, 53703-2865, US

(21) Appl. No.: 12/426,371

(22) Filed: Apr. 20, 2009

Related U.S. Application Data
(63) Continuation-in-part of application No. 11/130,969, filed on May 17, 2005, now abandoned.

(51) Int. Cl. B43K 29/00; G09F 3/00

(52) U.S. Cl. 40/334

(57) ABSTRACT

Disclosed is a pen or other writing instrument removably displaying a photograph or other image. The pen includes a body element and a transparent display barrel removably disposable over the body element. The display barrel has an inner diameter slightly larger than the outer diameter of the body element, defining a chamber for displaying the photo. The display barrel is removably secured around the body element with a securing means.

### CROSS-REFERENCE TO RELATED APPLICATIONS

This is a continuation-in-part of co-pending application Ser. No. 11/130,969, filed May 17, 2005, which is incorporated herein by reference.

### FIELD OF THE INVENTION

The present invention relates generally to a photo-display pen which facilitates the easy removal and installation of different photos or images in a pen.

### BACKGROUND OF THE INVENTION

There are many devices in the prior art which display a picture or other image. For instance, U.S. Pat. No. 3,374,911 discloses a plastic cosmetic jar assembly which tightly and permanently confines a picture between an insert plastic liner and an outer transparent shell. However, the picture, once installed, cannot be removed unless the liner is forcibly separated from the shell.

Photo displays have also been provided for other containers. For instance, U.S. Pat. No. 2,844,893 describes a container surrounded by an outer label-retaining member which permits a label to be changed at will. The label is inserted and removed through a slot on the member.

Further, there are many inventions directed to the display of elements on pens. For instance, U.S. Pat. No. 4,798,016 describes a pen cap with a transparent sleeve surrounding a cylindrical tube, with the photo displayed in between the sleeve and tube. An elongated viewing window is provided in U.S. Pat. No. 6,386,780, allowing an image to be inserted from the side of the window laterally into the space between the window and the instrument.

Other inventions are directed to the display of images specially manufactured for the article. U.S. Pat. Nos. 4,207,695; 6,257,789; and 6,742,953 show pens bearing images selected and installed during manufacture of the pens. Most images are intended to serve advertising purposes. However, the images are not intended to be removed and exchanged and cannot be personally adapted to the individual user.

### SUMMARY OF THE INVENTION

The invention is directed to a writing instrument dimensioned and configured to removably display an image. The writing instrument may be a pen, pencil, marker, etc. For brevity only, the discussion that follows is generally related to a pen. The writing instrument comprises an elongated body element having an outer surface and a transparent display barrel removably disposable over the outer surface of the body element. The display barrel has an opening at a first end for receiving the body element, and an inner surface substantially complementary in shape to the outer surface of the body element. In combination, the body element and the display barrel define a chamber in which an image can be displayed. A fastener is provided to secure the display barrel to the body element. The fastener is dimensioned and configured to secure the display barrel to the body element, either via a frictional engagement or via mating threads on the fastener and the body element.

In the preferred embodiment, the fastener is a collar disposed at a second end of the display barrel. The collar is essentially a flattened annulus or ring, having a first opening for engaging the display barrel and a second opening opposite the first opening for accommodating an activation point for the writing instrument. That is, when the collar engages the body of the writing instrument, it urges the display barrel into a mating engagement with the body element, while at the same time providing a void through which can pass the button for extending and retracting a ball-point pen mechanism or for extending lead (in the case where the writing instrument is a mechanical pencil).

The invention also comprises a writing instrument having a substantially cylindrical, conical, or bullet-shaped body element housing an ink assembly; a transparent display barrel removably disposable over the body element, the display barrel having a first end for receiving the body element, and an inner surface substantially complementary in shape to the outer surface of the body element and which, in combination with the body element, defines a chamber in which an imaged can be displayed; a fastener dimensioned and configured for removably securing the display barrel to the apparatus; and a cap dimensioned and configured to fit over an end of the body element.

### BRIEF DESCRIPTION OF THE DRAWINGS

FIG. 1 is a perspective view of the photo-display pen 10.

FIG. 2 is an exploded view of the photo-display pen 10 illustrating how the photo 12 can be inserted and removed from the pen 10.

FIG. 3 is an exploded view of the photo-display pen 10 with cap 30.

FIG. 4A is an exploded, cutaway view of a second version of the photo-display pen. FIG. 4B is an exploded front elevation view of the cutaway view shown in FIG. 4A.

FIG. 5A is an exploded, cutaway view of a third version of the photo-display pen. FIG. 5B is an exploded front elevation view of the cutaway view shown in FIG. 5A.

### DETAILED DESCRIPTION OF THE INVENTION

Referring to the drawings, where like reference numbers designate like or corresponding parts throughout, there is shown a writing instrument 10 that is dimensioned and configured to display a removable image or photo 12.

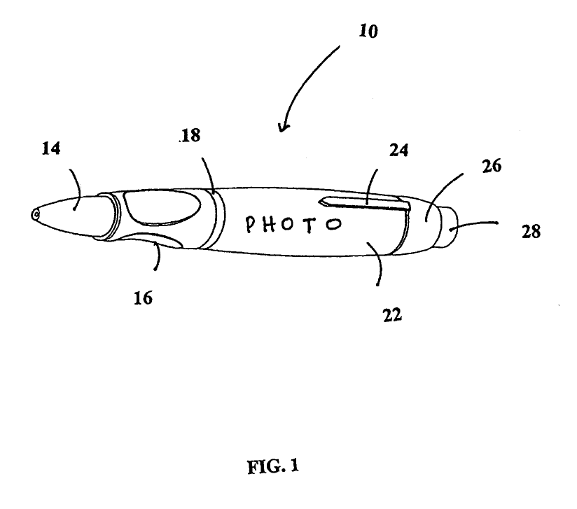

Referring to FIG. 1, a preferred version of the writing instrument 10 is shown. The writing instrument 10 includes a point 14, a grip 16, a decorative piece 18, a body element 20, a display barrel 22, a clip 24, a fastener, such as a collar 26, and a pressing tip or eraser 28. The writing instrument 10 preferably houses a standard press-action, ink sub-assembly (not shown), such as a ball point pen or marker, both of which are well known in the art. Alternatively, the writing instrument may include a mechanical pencil sub-assembly (not shown), also well known in the art. For purposes of brevity only, the description that follows will refer to a pen 10. The invention, however, encompasses a writing instrument of any mechanism, e.g., pen, pencil, marker, fountain pen, etc.

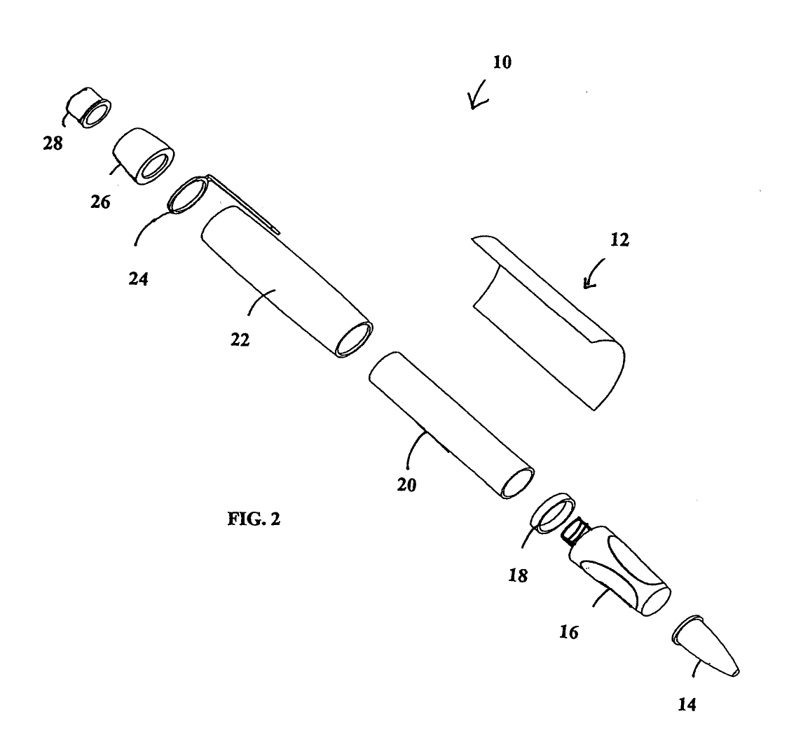

Referring to FIG. 2, the grip 16 of the pen 10 has a first end forming a removable metal point, a contoured middle portion, and a second, opposing end configured to threadedly engage the body element 20. The contoured middle portion of the grip 16 is preferably made of a soft rubber or other flexible material. The contours correspond to the dimensions of a writer's fingers, increasing the comfort of using the writing instrument 10.

The first end of the grip 16 ends in a point 14, through which the ink assembly (not shown) exits the pen 10 for writing. In use, the writer activates the ink assembly by pressing the pressing tip 28 positioned opposite the point 14 of the pen 10.

The second end of the grip 16, located opposite the first end, is configured to threadedly engage a first end of the elongated body element 20. The body element 20 is a substantially cylindrical, conical, or bullet-shaped element which houses the ink assembly (not shown). A first end of the body element 20 is configured to engage the grip 16. A second, opposing end of the body element 20 is configured to engage a collar 26, either by means of a frictional engagement or via mating threads.

The outer surface of the body element 20 is complementary to the inner surface of the grip 16. When the grip 16 engages the body element 20, a leading edge is formed between the grip 16 and the body element 20. In a preferred version, a decorative piece 18 may be used to cover this leading edge connection of the grip 16 and body element 20.

The body element 20 also supports a display barrel 22. The display barrel 22 is a transparent, hollow member that is removably disposable over the body element 20. The display barrel 22 is preferably made of a transparent material such as glass or plastic.

The outer diameter of the display barrel 22 corresponds with the outer diameter of the decorative piece 18. Thus, when disposed around the body element 20, one end of the display barrel 22 is aligned with and adjacent to the decorative piece 18.

The outer surface of the body element 20 is substantially complementary to the inner diameter of the display barrel 22. In combination, the body element and the display barrel defines a chamber in which a photo 12 or other image can be displayed. To decrease rubbing and other wear on the photo 12 or other image displayed in the display barrel 22, the depth of the chamber preferably remains relatively constant on either side of the pen 10 during use.

In a preferred version, the display barrel 22 defines a chamber of sufficient size to display a standard 2″×3″ photo. In that instance the chamber, if cylindrical, would have a diameter of roughly ⅝ of an inch. However, the display barrel 22 may have larger or smaller diameters, depending on the size of the photo 12 or other image to be displayed. For instance, a 3×5 inch photo will require a display barrel with a larger diameter.

In use, a photo 12 or other image is inserted into the display barrel 22 and positioned for display. The first end of the display barrel 22 is then inserted around the body element 20, thus positioning the photo 12 in the chamber defined between the body element 20 and the display barrel 22. When in position, one end of the display barrel 22 is adjacent to the decorative piece 18, and the outer diameter of the display barrel 22 aligns with the outer diameter of the decorative piece 18.

When the first end of the display barrel 22 is in position, a second, opposing end of the display barrel 22 is aligned adjacent to the first end of the collar 26. The first end of the collar 26 threadedly engages the second end of the body element 20, securing the display barrel 22 between the decorative piece 18 and the collar 26.

In the preferred embodiment, the collar 26 has a first end configured to threadedly engage the second end of the body element 20. The outer diameter of the collar 26 is slightly larger than the outer diameter of the body element 20, corresponding with the outer diameter of the display barrel 22. In this way, the display barrel 22 is removably secured around the body element 20, with one end of the display barrel 22 adjacent to the decorative piece 18 and the second, opposing end of the display barrel 22 adjacent to the collar 26.

In an alternate version, a clip 24 may be inserted between the display barrel 22 and the collar 26.

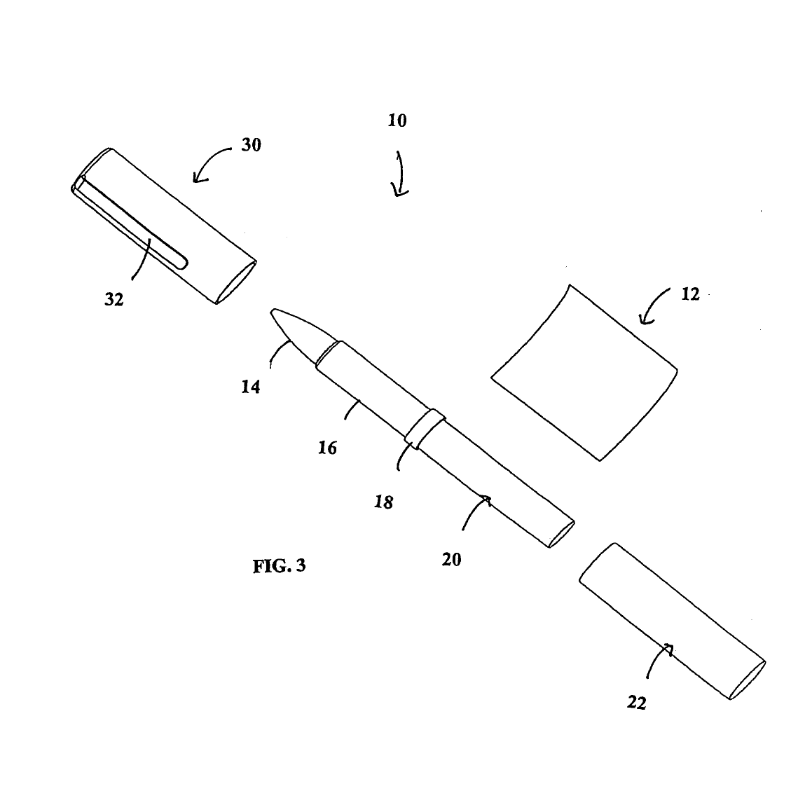

In one version of the invention (FIG. 2), the second end of the collar 26 is configured to accommodate the press tip 28 of the ink assembly. In an alternate version (FIG. 3), the second end of the collar 26 is configured to accommodate the cap 30. In this version, the body element 20 houses a standard ink assembly, extending through the point 14.

The cap 30 is configured to frictionally engage the outer diameter of the grip 16, protecting the point 14 and ink assembly (not shown). The cap 30 may contain a clip 32. To write, the cap 30 is removed and preferably stored on the collar 26 by frictionally engaging the outer diameter of the collar 26. When writing is complete, the cap 30 is inserted over the point 14 and grip 16 of the pen 10 until the inner diameter of the cap 30 frictionally engages the outer diameter of the grip 16.

In FIGS. 1-3, the photo 12 or other image is removed by releasing the collar 26, removing the display barrel 22, and removing the photo 12 or image. When a new photo 12 is replaced, the first end of the display barrel 22 is inserted over the body element 20 and aligned adjacent to the decorative piece 18. The collar 26 is then threadedly engaged with the body element 20, removably securing the display barrel 22 and photo 12 between the collar 26 and decorative piece 18.

The photo-display pen 10 of the present invention is intended for the display of photos. However, other images may also be displayed, such as a drawing, a poem, a reference chart, a souvenir or another personal item.

Further, while the present invention is described above in terms of a pen 10, this is not a limitation of the invention. Other cylindrical elements, such as lipstick containers and the like, can be provided with a display barrel 22 and collar 26 or decorative piece 18 for removably securing the display barrel 22 to the element. In short, every photo or image is a potential source of art for display, and any sort of cylindrical element becomes a potential display item.

Although specific features of the invention are shown in some drawings and not others, this is for convenience only. Each feature may be combined with any or all of the other features in accordance with the invention.

As noted above, in this first version of the photo-display pen, the body element 20 and the display barrel 22 define a chamber in which a photo 12 or other image can be displayed. See FIG. 2. The depth of the chamber is, in the preferred embodiment, relatively shallow so that a snug fit is obtained when the photo is 12 is inserted into the chamber. However, if materials of thicker width are to be inserted into the chamber, it is helpful to have a structure that defines the chamber with greater precision. It is also desirable to have a structure that is rigid and feels good in the users' hands even when there is no photo in the chamber.

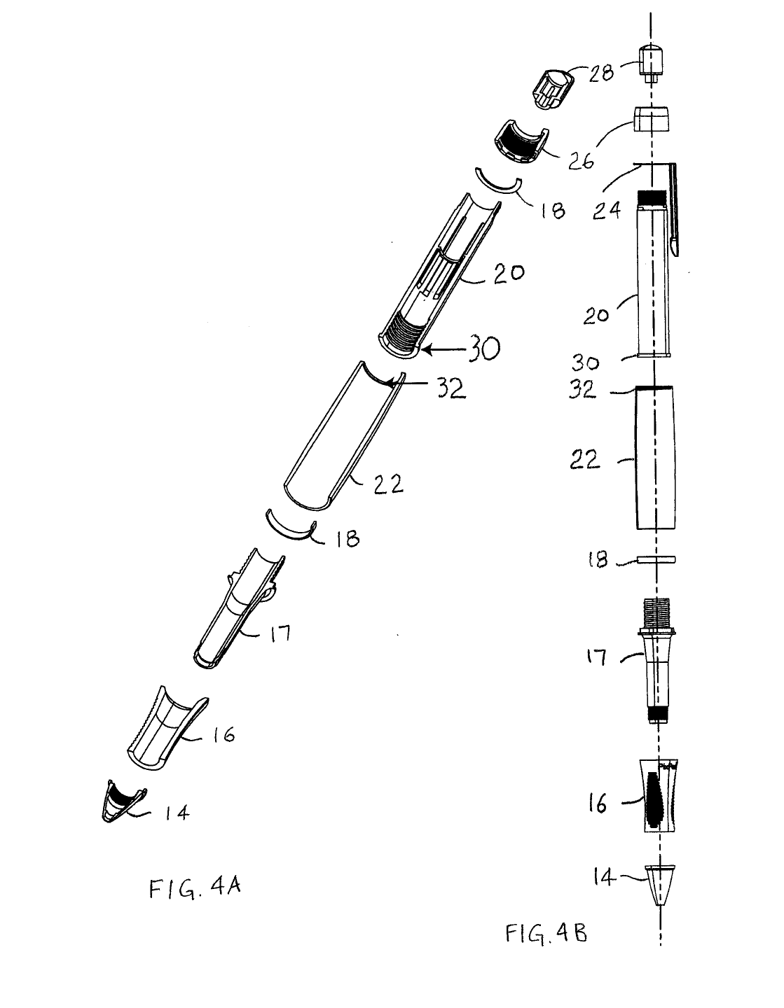

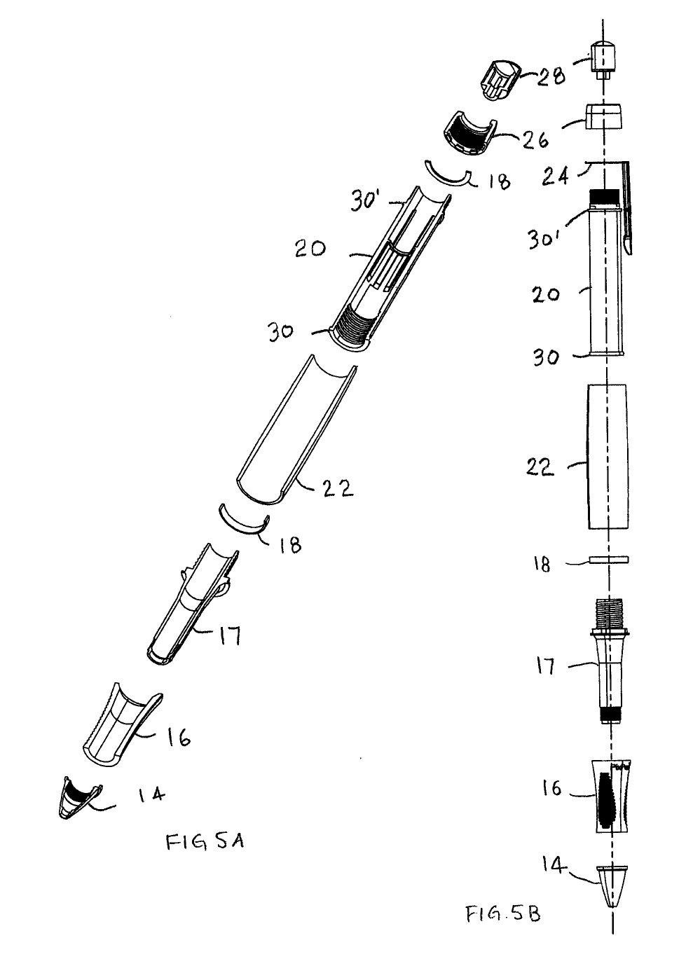

To achieve these ends, different versions of the photo-display pen, as shown in FIGS. 4A, 4B, 5A, and 5B are provided. Referring now to all four of FIGS. 4A, 4B, 5A, and 5B, a writing instrument 10 is shown. As in the version described earlier, the writing instrument 10 includes a point 14, a grip 16, decorative pieces 18 (optional), a body element 20, a display barrel 22, a clip 24 (optional), a fastener, such as a collar 26, and a pressing tip or eraser 28. Additionally a connector 17 is provided. The connector 17 has a first end dimensioned and configured to matingly engage with the point 14, either via mating threads or a friction engagement or any suitable permanent or reversible engagement. The connector has a second, opposing end configured matingly engage with the body element 20, either via mating threads (preferred) or a friction engagement or any suitable permanent or reversible engagement.

The body element 20 is a substantially cylindrical, conical, or bullet-shaped element which houses the ink assembly (not shown). A first end of the body element 20 is configured to engage the second end of the connector 17. A second, opposing end of the body element 20 is configured to engage a collar 26, either by means of a frictional engagement or via mating threads.

The body element 20 is dimensioned and configured to fit within display barrel 22. The display barrel 22 is a transparent, hollow member that is removably disposable over the body element 20. The display barrel 22 has a first end dimensioned and configured to about the grip 16, and an opposing second end dimensioned and configured to abut collar 26. Again, The display barrel 22 is preferably made of a transparent material such as glass or plastic.

In the version of the photo-display pen shown in FIGS. 4A and 4B, an outside diameter flange or spacer 30 is provided on the first end of the body element 20. Additionally, an inside diameter flange or spacer 32 is provided on the second end of the display barrel 22. The outside diameter flange 30 on the body element 20 is dimensioned to snugly engage the inside surface of the display barrel 22 when the body element 20 is placed inside the display barrel 22. Likewise, the inside diameter flange 32 on the display barrel 22 is dimensioned to snugly engage the outside surface of the body element 20 when the body element 20 is placed inside the display barrel 22. In this fashion, when the writing instrument is fully assembled, the depth of the chamber defined by the inner surface of the body element 20 and the display barrel 22 is defined by the height of the flanges 30 and 32. The flange 30 makes firm contact with the inner surface of the display barrel 22, and the flange 32 makes firm contact with the outside surface of the body element 20. This is the case whether or not there is a photo inserted within the chamber defined by the body element and display barrel.

Another version of the photo-display pen is depicted in FIGS. 5A and 5B. This version is identical to the version shown in FIGS. 4A and 4B with the exception that there is no inside diameter flange on the display barrel 22, but rather an additional outside flange or spacer 30′ provided on the second end of the body element 20. In the same fashion as flange 30, the outside diameter flange 30′ on the body element 20 is dimensioned to snugly engage the inside surface of the display barrel 22 when the body element 20 is placed inside the display barrel 22. The two outside diameter flanges 30 and 30′ make firm contact with the inner surface of the display barrel 22. This is the case whether or not there is a photo inserted within the chamber defined by the body element and display barrel. With this structural arrangement, the writing instrument 10 has a nice firm feel whether or not there is a photo displayed within the chamber.

It is understood that the invention is not confined to the particular construction and arrangement of parts herein illustrated and described, but embraces such modified forms thereof as come within the scope of the following claims.

What is claimed is:

1. A writing instrument dimensioned and configured to removably display an image, the writing instrument comprising:
an elongated body element having an outer surface and at least one flange or spacer protruding therefrom;
a transparent display barrel removably disposable over the outer surface of the body element and in contact with the flange or spacer protruding from the body element, the display barrel having an opening at a first end for receiving the body element, and an inner surface substantially complementary in shape to the outer surface of the body element and which, in combination with the body element, defines a chamber in which an image can be displayed;
a fastener dimensioned and configured to secure the display barrel to the body element, wherein the fastener is a collar disposed at a second end of the display barrel, the collar having a first opening for securing the display barrel and a second opening opposite the first opening for accommodating an activation point for the writing instrument; and
a clip removably secured between the second end of the display barrel and the first opening of the collar.

2. The writing instrument of claim 1 wherein the collar threadedly engages the second end of the display barrel.

3. The writing instrument of claim 1, wherein the elongated body element has a first end and a second end, and the at least one flange or spacer comprises a first outside diameter flange protruding from the first end of the body element and a second outside diameter flange protruding from the second end of the body element.

4. The writing instrument of claim 1, wherein the elongated body element has a first end and a second end, and the at least one flange or spacer comprises one outside diameter flange protruding from the second end of the body element, and further comprising an inside diameter flange protruding from the first end of the display barrel, wherein the inside diameter flange contacts the outer surface of the elongated body element.

5. A writing instrument dimensioned and configured to removably display an image, the writing instrument comprising:
a substantially cylindrical, conical, or bullet-shaped body element and at least one flange or spacer protruding therefrom;
a transparent display barrel removably disposable over the body element and in contact with flange or spacer protruding from the body element, the display barrel having a first end for receiving the body element, and an inner surface substantially complementary in shape to the outer surface of the body element and which, in combination with the body element, defines a chamber in which an imaged can be displayed;
a fastener dimensioned and configured for removably securing the display barrel to the body element, wherein the fastener includes a collar disposed at a second, opposing end of the display barrel, the collar having a first end configured to threadedly engage the body element; and
a cap dimensioned and configured to fit over an end of the body element, wherein the cap includes a clip.

6. The writing instrument of claim 5, wherein the cap has a first end configured to frictionally engage the body element.

7. The writing instrument of claim 5, wherein the collar threadedly engages the second end of the display barrel.

8. The writing instrument of claim 5, wherein the body element has a first end and a second end, and the at least one flange or spacer comprises a first outside diameter flange protruding from the first end of the body element and a second outside diameter flange protruding from the second end of the body element.

9. The writing instrument of claim 5, wherein the body element has a first end and a second end, and the at least one flange or spacer comprises one outside diameter flange protruding from the second end of the body element, and further comprising an inside diameter flange protruding from the first end of the display barrel, wherein the inside diameter flange contacts the outer surface of the elongated body element.

10. A writing instrument dimensioned and configured to removably display an image, the writing instrument comprising:
a support element having an outer diameter and at least one flange or spacer protruding therefrom;
a grip matingly engaged to a first end of the support element;
a transparent display barrel removably disposable over the support element and having an inner diameter slightly larger than the outer diameter of the support element for defining a chamber to accommodate an image; and
a fastener for removably securing the display barrel around the support element, wherein the fastener includes a leading edge at a first end of the display barrel and a collar disposed at a second, opposing end of the display barrel; and
wherein the support element has one end configured to matingly engage the grip and a second, opposing end configured to matingly engage the collar.

11. The writing instrument of claim 10, further comprising an image disposed in the chamber.

12. The writing instrument of claim 11, wherein the image is a photograph.

13. The writing instrument of claim 10 wherein the collar threadedly engages the second end of the display barrel.

14. The writing instrument of claim 10, wherein the support element has a first end and a second end, and the at least one flange or spacer comprises a first outside diameter flange protruding from the first end of the support element and a second outside diameter flange protruding from the second end of the support element.

15. The writing instrument of claim 10, wherein the support element has a first end and a second end, and the at least one flange or spacer comprises one outside diameter flange protruding from the second end of the support element, and further comprising an inside diameter flange protruding from the first end of the display barrel, wherein the inside diameter flange contacts the outer surface of the support element.
